(19) United States
(12) Patent Application Publication
(10) Pub. No.: US 2019/0303816 A1
(43) Pub. Date: Oct. 3, 2019

(54) CLOUD WORKSPACE ASSIGNMENT BY USER LOCATION

(71) Applicant: Citrix Systems, Inc., Fort Lauderdale, FL (US)

(72) Inventors: Timothy Jay Moore, San Diego, CA (US); Nicholas Walter Siryk, Boca Raton, FL (US)

(21) Appl. No.: 15/943,180

(22) Filed: Apr. 2, 2018

(51) Int. Cl. G06Q 10/06; G06F 9/451; H04L 29/08; H04W 4/029

(52) U.S. Cl. CPC G06Q 10/0631; H04W 4/029; H04L 67/34; G06F 9/452

(57) ABSTRACT

Described embodiments provide systems and methods of assigning workspaces. A workspace manager executable on a server may receive a request for a workspace to be assigned to a user. The request may indicate a location of the user. The workspace manager may identify, according to one or more preconfigured policies, from a plurality of workspaces configured for possible locations of the user, a first workspace configured for the indicated location and having one or more applications predetermined for the first user and the indicated location. The workspace manager may assign the identified first workspace configured for the indicated location and having the one or more applications predetermined for the first user and the indicated location.

### FIELD OF THE DISCLOSURE

The present application generally relates to workspace management, including but not limited to systems and methods for assigning workspaces.

### BACKGROUND

Upon separate receipt of individual requests, workspaces may be assigned to end users by an administrator. In assigning workspaces, the administrator may be unaware of the locations of each individual end user or applications to be used by each end user. This may result in potential delays in workspace assignment, especially during transient and rapid movement of end users among the workspaces.

### BRIEF SUMMARY

The present disclosure is directed towards systems and methods of assigning workspaces. Each workspace may include a set of applications and/or services along with stored user data. The applications, services, and/or user data of the workspace may be accessible via one or more remote desktop session. The remote desktop sessions may be maintained by a server. The server may be part of a cloud-based service, such as an Infrastructure as a Service (IaaS), Software as a Service (SaaS), or a Platform as a Service (PaaS). Under alternative techniques, the workspaces may be assigned by an administrator to users upon request. The request may indicate a request for a workspace to be assigned to a user. The administrator may be unaware of the locations of each user and the applications, services, and data to be utilized by each user. As a result, there may be potential delays in workspace assignment and reduced accessibility of resources to the user. These delays and reduced accessibility may be exacerbated especially when there is a transient and rapid movement of users (e.g., during natural disasters or other emergencies), because not enough new workspaces may be instantiated in time in response to the requests by users. Moreover, the administrator may assign workspaces without taking into account the consumption of computing resources of the server hosting the workspaces utilized by other users. Consequently, even if a user is able to be assigned to a workspace, the applications and services of the workspace may be running at a suboptimal rate.

To address the technical challenges and drawbacks in assigning workspaces, the present systems and methods provide an assignment of workspaces to users based on locations of users and/or utilization of workspaces by other users. An agent (e.g., a plug-in or an extension for an application, or a separate, standalone application) may be assigned on a client of the user. When executing, the agent may check with a workspace manager on a server to determine whether assignment by location is enabled for a location of the user. If the assignment by location feature is enabled for the location, the agent may generate a request for a workspace to be assigned to the user upon an action or interaction by the user. The request may include the location of the user. The location may correspond to a physical location (e.g., a geographic coordinate or a mailing address, via Wi-Fi or global positioning system (GPS) positioning for instance) or to a network address (e.g., an Internet Protocol (IP) address or a Media Access Control (MAC) address). The request may also identify resources to be used by the user, such as applications, services, and/or other files. Once generated, the agent may transmit the request for the workspace to a workspace manager running on a server.

On the server, the workspace manager may search for available workspaces at or near the location indicated by the request. Which workspace(s) or type(s) of workspace are available to be assigned may depend on the location of the user due to various factors. Such factors in assigning workspaces may include privacy controls for the jurisdiction of the location, network bandwidth available at the location, and other location-specific policies and configurations, among others. From the available workspaces found at the location, the workspace manager may also identify workspaces assigned to other users at or near the location indicated by the request. The workspace manager may filter the available workspaces by applying a policy. The policy may specify the workspaces permitted to be assigned by location and resources requested by users. Out of the remaining available workspaces, the workspace manager may assign a workspace for the user. Once assigned, the user may execute, run, or otherwise use the applications, services, and files of the workspace.

At least one aspect of this disclosure is directed to a method of assigning workspaces. A workspace manager executable on a server may receive a request for a workspace to be assigned to a user. The request may indicate a location of the user. The workspace manager may identify, according to one or more preconfigured policies, from a plurality of workspaces configured for possible locations of the user, a first workspace configured for the indicated location and having one or more applications predetermined for the first user and the indicated location. The workspace manager may assign the identified first workspace configured for the indicated location and having the one or more applications predetermined for the first user and the indicated location.

In some embodiments, the workspace manager may receive the request from a device of the user. The device may determine the location of the user. In some embodiments, the workspace manager may receive the request from an agent on a device of the user. The agent may be received from the server for execution on the device.

In some embodiments, the workspace manager may configure the one or more preconfigured policies to assign each of the possible locations of the user to one of the plurality of workspaces. In some embodiments, the workspace manager may configure the one or more preconfigured policies to assign, for each of the possible locations of the user, a corresponding set of one or more applications to the user.

In some embodiments, the workspace manager may configure the one or more preconfigured policies to assign, for each of a plurality of possible types of devices that the user can operate, one of the plurality of workspaces. In some embodiments, the workspace manager may identify, from the plurality of workspaces configured for possible locations of the user, the first workspace according to a type of device associated with the user at the indicated location.

In some embodiments, the workspace manager may determine workspaces of other users at the indicated location. In some embodiments, the workspace manager may identify the first workspace according to the determination. In some embodiments, the identified first workspace may include a remote desktop session.

At least one aspect of this disclosure is directed to a system for assigning workspaces. The system may include memory of a server for storing one or more preconfigured policies. The system may include a workspace manager executable on the server. The workspace manager may receive a request for a workspace to be assigned to a user. The request may indicate a location of the user. The workspace manager may identify, according to one or more preconfigured policies, from a plurality of workspaces configured for possible locations of the user, a first workspace configured for the indicated location and having one or more applications predetermined for the first user and the indicated location. The workspace manager may assign the identified first workspace configured for the indicated location and having the one or more applications predetermined for the first user and the indicated location.

In some embodiments, the workspace manager may receive the request from a device of the user. The device may determine the location of the user. In some embodiments, the workspace manager may receive the request from an agent on a device of the user. The agent may be received from the server for execution on the device.

In some embodiments, the workspace manager may configure the one or more preconfigured policies to assign each of the possible locations of the user to one of the plurality of workspaces. In some embodiments, the workspace manager may configure the one or more preconfigured policies to assign, for each of the possible locations of the user, a corresponding set of one or more applications to the user.

In some embodiments, the workspace manager may configure the one or more preconfigured policies to assign, for each of a plurality of possible types of devices that the user can operate, one of the plurality of workspaces. In some embodiments, the workspace manager may identify, from the plurality of workspaces configured for possible locations of the user, the first workspace according to a type of device associated with the user at the indicated location.

In some embodiments, the workspace manager may determine workspaces of other users at the indicated location. In some embodiments, the workspace manager may identify the first workspace according to the determination. In some embodiments, the identified first workspace may include a remote desktop session.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram of embodiments of a computing device;

FIG. 2 is a block diagram of an example embodiment of a system for assigning workspaces;

FIG. 3 is a functional band diagrams of an example embodiment of a method for assigning workspaces; and

FIG. 4 is a flow diagram of an embodiment for a method of assigning workspaces.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes systems and methods for assigning workspaces.

### A. Computing Environment

Prior to discussing the specifics of embodiments of the systems and methods detailed herein in Section B, it may be helpful to discuss the computing environments in which such embodiments may be deployed.

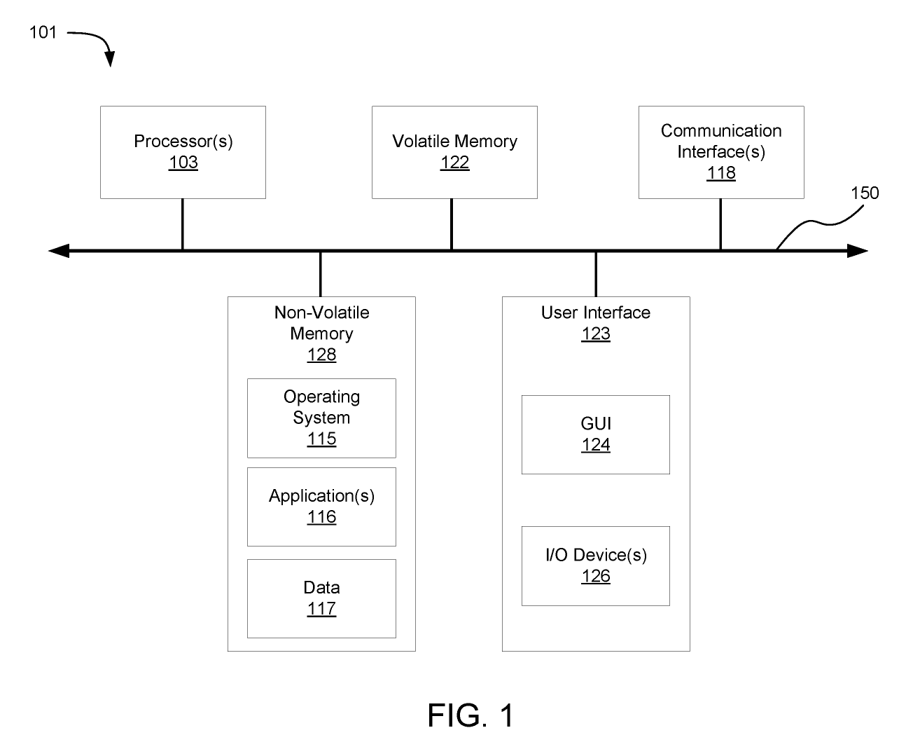

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1 is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Additional details of the implementation and operation of network environment, computer 101 and client and server computers may be as described in U.S. Pat. No. 9,538,345, issued Jan. 3, 2017 to Citrix Systems, Inc. of Fort Lauderdale, Fla., the teachings of which are hereby incorporated herein by reference.

### B. Systems and Methods for Assigning Workspaces

The present disclosure is directed towards systems and methods of assigning workspaces. Each workspace may include a set of applications and services along with stored user data. The applications, services, and user data of the workspace may be accessible via one or more remote desktop session. The remote desktop sessions may be maintained by a server. The server may be part of a cloud-based service, such as an Infrastructure as a Service (IaaS), Software as a Service (SaaS), or a Platform as a Service (PaaS). Under alternative techniques, the workspaces may be assigned by an administrator to users upon request. The request may indicate a demand for a workspace to be assigned to a user. The administrator may be unaware of the locations of each user and the applications, services, and data to be utilized by each user. As a result, there may be potential delays in workspace assignment and reduced accessibility of resources to the user. These delays and reduced accessibility may be exacerbated especially when there is a transient and rapid movement of users (e.g., during natural disasters or other emergencies), because not enough new workspaces may be instantiated in time in response to the requests by users. Moreover, the administrator may assign workspaces without taking into account the consumption of computing resources of the server hosting the workspaces utilized by other users. Consequently, even if a user is able to be assigned to a workspace, the applications and services of the workspace may be running at a suboptimal rate.

To address the technical challenges and drawbacks in assigning workspaces, the present systems and methods can provide an assigning of workspaces to users based on locations of users and/or utilization of workspaces by other users. An agent (e.g., a plug-in or an extension for an application or a separate, standalone application) may be assigned on a client of the user. When executing, the agent may check with a workspace manager on a server to determine whether assignment by location is enabled for a location of the user. If the assignment by location feature is enabled for the location, the agent may generate a request for a workspace to be assigned to the user upon an action or interaction by the user (e.g., via a graphical user interface of the agent). The request may include the location of the user. The location may correspond to a physical location (e.g., a geographic coordinate or a mailing address) or to a network address (e.g., an Internet Protocol (IP) address or a Media Access Control (MAC) address). The request may also identify resources to be used by the user, such as applications, services, and other files. Once generated, the agent may transmit the request for the workspace to a workspace manager running on a server.

On the server, the workspace manager may search for available workspaces at or near the location indicated by the request. Which workspaces or types of workspace available to be assigned may depend on the location of the user due to various factors. Such factors in assigning workspaces may include privacy controls for the jurisdiction of the location, network bandwidth available at the location, and other location-specific policies and configurations, among others. From the available workspaces found at the location, the workspace manager may also identify workspaces assigned to other users at or near the location indicated by the request. The workspace manager may filter the available workspaces by applying a policy. The policy may specify the workspaces permitted to be assigned by location and/or resources requested by users. Out of the remaining available workspaces, the workspace manager may assign a workspace for the user. Once assigned, the user may execute, run, or otherwise use the applications, services, and files of the workspace.

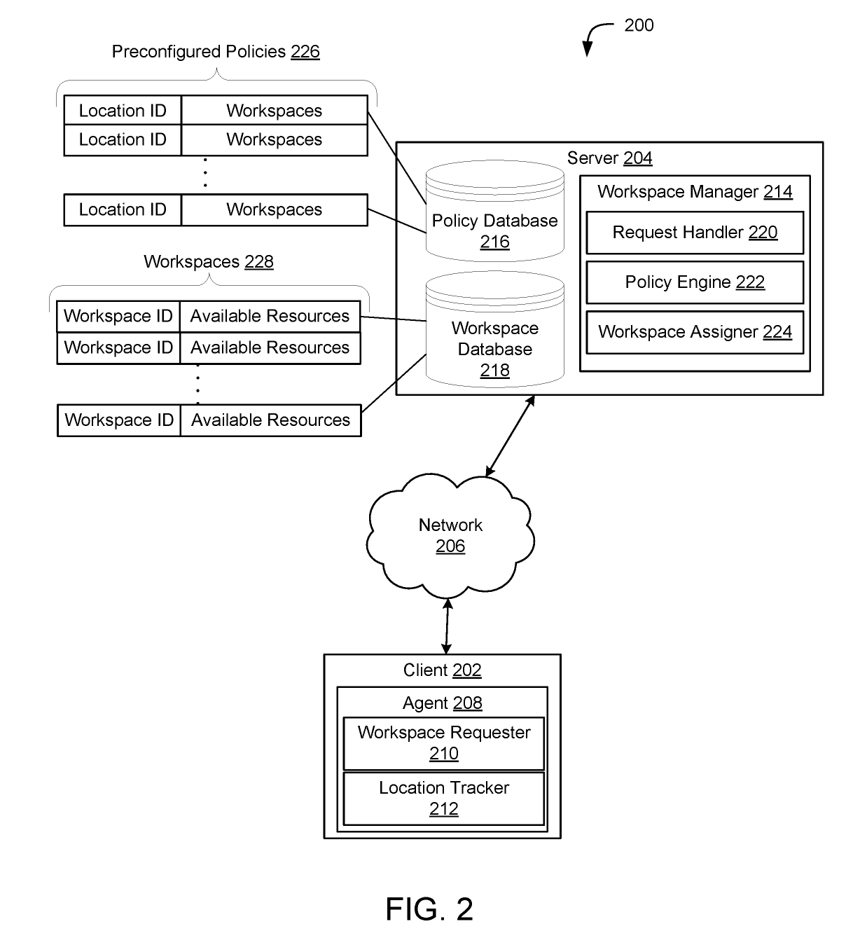

Referring now to FIG. 2, depicted is a block diagram of a system 200 for assigning workspaces. In overview, the system 200 may include a client 202, a server 204 communicatively coupled via a network 206. The client 202 may include an agent 208. The agent 208 may include a workspace requester 210 and/or a location tracker 212. The server 204 may include a workspace manager 214, a policy database 216, and/or a workspace database 218, among other elements. In some embodiments, the workspace database 218 may be a separate component in communication with the server 204 via the network 206. The workspace manager 214 may include a request handler 220, a policy engine 222, and/or a workspace assigner 224, among others.

Each of the above-mentioned elements or entities is implemented in hardware, or a combination of hardware and software, in one or more embodiments. Each component of the system 200 may be implemented using hardware or a combination of hardware or software detailed above in connection with FIG. 1. For instance, each of these elements or entities can include any application, program, library, script, task, service, process or any type and form of executable instructions executing on hardware of the client 202 (including the workspace requester 210 and the location tracker 212 and the agent 208) and the server 204 (including the request handler 220, the policy engine 222, and the workspace assigner 224 of the workspace manager 214, the policy database 216, and the workspace database 218). The hardware includes circuitry such as one or more processors in one or more embodiments.

The client 202 may download or otherwise receive the agent 208 from the server 204. In some embodiments, the client 202 may send a request for the agent 208 to the server 204. For example, a user of the client 202 can initiate a request, download and/or installation of the agent 208. The server 204 in turn may send the agent 208 to the client 202. In some embodiments, the server 204 may send a setup or installation application for the agent 208 to the client 202. Upon receipt, the client 202 may install the agent 208 onto a hard disk of the client 202. In some embodiments, the client 202 may run the setup application to unpack or decompress a package of the agent 208. In some embodiments, the agent 208 may be an extension (e.g., an add-on, an add-in, an applet or a plug-in) to another application (e.g., a web browser) installed on the client 202. The client 202 may install the agent 208 to interface or inter-operate with the pre-installed application. In some embodiments, the agent 208 may be a standalone application. The client 202 may install the agent 208 to execute as a separate process.

During execution of the agent 208 by the client 202, the workspace requester 210 may generate a request for a workspace to be assigned to a user of the client 202. The workspace may include one or more remote desktop sessions and/or remote application sessions to access resources hosted thereon. The workspace may include an interface, such as a graphical user interface (GUI), and can include one or more applications, files and/or other resources. In some embodiments, the workspace requester 210 may generate the request in response to a user input on a graphical user interface element for the agent 208 received via an input/output device of the client 202. The request for the workspace to be assigned may include a location of the user. The location may be specified by the user, e.g., via user input using an interface of the agent 208, for instance. The location of the user may include a geographic location (e.g., a geographic coordinate, a mail address, or a physical address), which can be obtained via GPS or Wi-Fi tracking or positioning by a location tracker 212 of the client 202 for example. For instance the location of the user or client 202 can include an address, or an indication/identification of a building, a city block, a town, a street, a zip code, a district, a state, a province, a country, a continent, an intranet, a locate area network, a wide area network, a metropolitan area network, a coverage region (e.g., of an internet service provider), a domain, an area code, a time zone, or any other geographical or network region. The location of the user may include a network address (e.g., an Internet Protocol (IP) address or a Media Access Control (MAC) address) of the client 202 for instance. A physical location of the user can be determined or estimated according to the IP address of the client for instance. The location of the user can be determined via geolocation determination by a location tracker 212 of the client 202. For example, the location tracker 212 and/or agent 208 at the client 202 can communicate with a geolocation server to determine a geographical location of the client 202 or user using a network address of the client. The geolocation server can include a repository or database of information mapping physical locations to network addresses for instance.

In some embodiments, in generating the request, the workspace requester 210 may invoke the location tracker 212 to determine the location of the user. Once invoked, the location tracker 212 may also identify or determine the location of the user. The location tracker 212 can include hardware (e.g., GPS receiver or Wi-Fi positioning system (WPS)) and software (e.g., GPS/WPS application, and/or the agent 208). The location tracker 212 may include a GPS module to determine the geographic location of the client 202. The location tracker 212 may also identify the network address from a communication interface of the client 202. In some embodiments, the request for the workspace to be assigned may include an identifier for the user (e.g., an account identifier) of the client 202. In some embodiments, the request for the workspace to be assigned may include a set of possible types of devices that the user can operate. The set of possible types of devices may include a smartphone, a tablet, a laptop, a desktop, a smart television, or any computing device.

The workspace requester 210 can include identifiers for resources (e.g., application name or file pathname) to be accessed via the workspace, into the request for the workspace. In some embodiments, the request for the workspace to be assigned may include one or more applications to be used by the user of the client 202. The one or more applications may include programs, software, daemons, or other executables to be accessed by the user via the workspace. The workspace requester 210 may identify the one or more applications based on user inputs on a graphical user interface element for the agent 208 received via the input/output device of the client 202. In some embodiments, the request for the workspace to be assigned may include one or more files to be accessed or edited by the user of the client 202. The one or more files may include any data files to be accessed and edited by the user using another application via the workspace. Once generated, the workspace requester 210 may transmit the request for the workspace to be assigned to the user of the client 202 to the server 204 via the network 206.

In some embodiments, the workspace requester 210 may determine whether an assignment by location feature is available and/or activated at the location of the user, prior to the generation or transmission of the request to the server 204. The workspace requester 210 may determine the location of the user by invoking the location tracker 212, such as the geographic location or the network address as detailed above. The workspace requester 210 may generate a query to the server 204 to determine whether the assignment by location feature is available at the location. The query may include the location of the user. In some embodiments, the workspace requester 210 may generate the query in response to a user input on the graphical user interface element for the agent 208 received via an input/output device of the client 202. Once generated, the workspace requester 210 may transmit the query to the server 204 via the network 206.

In response to receiving the query from the client 202, the request handler 220 executing on the server 204 may determine whether the assignment by location feature is available at the location indicated in the query. The request handler 220 may access the policy database 216 to determine whether the feature is available at the location. The policy database 216 may include a feature policy. The feature policy may specify whether the assignment by location feature is available at a particular location. For example, the feature policy may specify that the feature is available in California, but not available in Nevada. In some embodiments, the request handler 220 may access the feature policy maintained on the policy database 216 to determine whether the feature is available at the location included in the query. If the feature is available at the location, the request handler 220 may generate a response indicating that the feature is available at the location. The request handler 220 may proceed with the functionalities of the workspace manager 214 as detailed herein below. Conversely, if the feature is unavailable at the location, the request handler 220 may generate a response indicating that the feature is unavailable at the location. The request handler 220 may also terminate the functionalities of the workspace manager 214 in accordance with the assignment by location feature. With the determination of whether the feature is available at the location, the request handler 220 may transmit the response to the client 202 via the network 206.

Based on the response received from the server 204, the workspace requester 210 may determine whether the assignment by location feature is available at the location of the user. The workspace requester 210 may parse the response received from the server 204. If the response indicates that the feature is unavailable at the location, the workspace requester 210 may determine that the feature is unavailable at the location. The workspace requester 210 may also terminate proceeding with the functionalities of the agent 208 in accordance with the assignment by location feature. Conversely, if the response indicates that the feature is available at the location, the workspace requester 210 may determine that the feature is available at the location. The workspace requester 210 may also proceed with the functionalities of the assignment by location feature. The workspace requester 210 may also generate and transmit the request for assignment of the workspace to the user to the server 204 via the network 206.

The request handler 220 may receive the request for the workspace to be assigned to the user from the client 202 via the network 206. In response to receiving the request, the request handler 220 may parse the request in assigning the workspace to the user. In some embodiments, the request handler 220 may parse the request for the workspace to identify the location of the user. In some embodiments, the request handler 220 may identify a set of locations of the user from the request. In some embodiments, the request handler 220 may identify a set of locations proximate to the user's location or otherwise associated with the location of the user. For example, when the geographic location of the user is provided with the request, the request handler 220 may identify a set of geographic locations within a predefined distance of the user (e.g., less than 3 kilometers). When the network address for the client 202 of the user is provided with the request, the request handler 220 may determine a set of network addresses associated with the client 202 of the user. The set of network addresses may include network addresses of the same private network or intranet as the client 202 (e.g., with the same network gateway), among others. The request handler 220 may identify and/or use any of these locations and/or addresses to identify or match with location identifiers of one or more of the preconfigured policies 226 for assigning workspaces.

The request handler 220 may determine the one or more resources for the user that made the request. In some embodiments, the request handler 220 may parse the request for the workspace to identify the resources to be accessed. In some embodiments, the request handler 220 may parse the request to identify the user identifier for the user of the client 202. In some embodiments, the request handler 220 may parse the request to identify the set of possible types of devices for the user. In some embodiments, the request handler 220 may parse the request to identify the one or more applications to be used by the user of the client 202. In some embodiments, the request handler 220 may parse the request to identify the one or more files to be accessed or edited by the user of the client 202. In some embodiments, the request handler 220 may determine the one or more resources for the user based on the user, the location indicated in the request, or the set of possible types of devices. The one or more resources may be specific to a particular user (or user identifier), a particular location, and/or the set of possible types of devices. The request handler 220 may access the policy database 216 to identify a resource policy. The resource policy may specify the one or more resources for the user based on the user, the location indicated in the request, and/or the set of possible types of devices. The request handler 220 may identify and/or use any of these resources to identify or match with one or more of the available workspaces 228, and/or one or more of the preconfigured policies 226 for assigning workspaces.

In accordance with a set of preconfigured policies 226 of the policy database 216, the policy engine 222 may identify a workspace from a plurality of workspaces 228. The preconfigured policies 226 maintained on the policy database 216 may specify a set of workspaces 228 for each possible location for the user. For example, each preconfigured policies 226 may specify available workspace(s) 228 for a corresponding location and/or for a corresponding user. In some embodiments, the preconfigured policies 226 may be indexed on the policy database 216 by location identifiers. Each location identifier can identify or correspond to a location, which can include an address, a building, a city block, a town, a street, a zip code, a district, a state, a province, a country, a continent, an intranet, a locate area network, a wide area network, a metropolitan area network, a coverage region (e.g., of an interne service provider), a domain, an area code, a time zone, or any other geographical or network region. For each location identifier, the set of preconfigured policies 226 may specify the set of workspaces 228. In some embodiments, the set of preconfigured policies 226 may specify the set of compatible types of devices for each workspace 228. In some embodiments, the set of preconfigured policies 226 may specify set of resources available via each workspace 228. Each workspace 228 may include or may be configured to provide access to one or more resources, such as one or more applications and/or files to be accessed via the one or more applications. In some embodiments, each workspace 228 may correspond to a physical computing device located at a remote location away from the client 202. In some embodiments, each workspace 228 may include a remote desktop session and/or remote application session in accordance to any variety of protocols, such as the Remote Desktop Protocol (RDP), Appliance Link Protocol (ALP), Remote Frame Buffer (RFB) Protocol, and Independent Computing Architecture (ICA) Protocol. Each workspace 228 may include one or more user interfaces (e.g., graphical user interfaces) to access the one or more resources hosted on the remote desktop. The workspaces 228 to be assigned may have been instantiated or established (e.g., via virtualization) prior to the receipt of the request from the user and may be currently running and/or ready for assigning to a user. In this manner, when the workspace 228 is assigned to the user, the user may be able to use the workspace 228 within minutes (or within some other defined timeframe) of the assignment. Each workspace 228 may be indexed by a workspace identifier in a workspace database 218. In some embodiments, the workspace identifier may include an address (e.g., of a server) to call or communicate with, to access the remote desktop/application session for the workspace 228. The workspace database 218 may identify one or more workspace identifiers for the workspaces 228 and the available resources for each workspace 228.

Using the location of the user or client 202 indicated in the request, the policy engine 222 may identify or select the workspace 228 to assign to the user in accordance with the preconfigured policies 226. The policy engine 222 may identify the workspace 228 to assign to the user based on locations identified as within a proximity of, or associated with the location of the user indicated in the request. In some embodiments, the policy engine 222 may traverse through the preconfigured policies 226 maintained on the workspace database 218 to search for the workspaces 228 for the location as indicated in the request from the client 202. The policy engine 222 may find or identify a subset of preconfigured policies 226 with one or more location identifiers matching the location of the user included in the request from the client 202. In some embodiments, the policy engine 222 may find or identify the subset of preconfigured policies 226 with the one or more location identifiers matching one of the set of location identifiers identified as within a proximity of, or associated with the location of the user.

The policy engine 222 may filter the set of workspaces 228 identified in the subset of preconfigured policies 226 for the location of the user to select the workspace 228 to assign to the user. In some embodiments, the policy engine 222 may determine a set of workspaces 228 assigned to other users at and/or within a proximity to the location of the user indicated in the request and the set of locations approximate or associated with the location of the user. Other workspaces 228 in, approximately at, within a proximity of, or associated with the location of the user that sent the request may be accessed by other users. As such, the resources of the workspaces 228 assigned to other users may be in use. The policy engine 222 may remove the set of workspaces 228 assigned to other users from the set of workspaces 228 at, approximate, or associated with the location of the user. From the remaining set of workspaces 228 (or available set of workspaces), the policy engine 222 may identify the set of available resource accessible via each workspace 228. The policy engine 222 may compare the set of available resources at each workspace 228, with the one or more resources indicated in the request from the user. In some embodiments, the policy engine 222 may determine a number of available resources at the workspace 228 matching the one or more resources indicated in the request from the user. Based on the comparison, the policy engine 222 may select the workspace 228 with the greatest number of available resources (e.g., matching the one or more resources indicated in the request). In some embodiments, the policy engine 222 may randomly select one of the available workspaces 228, or select a first one of the available workspaces 228, or select one of the available workspaces 228 with the most available resources.

In some embodiments, the policy engine 222 may determine a number of assigned and unassigned workspaces 228 at, within a proximity of, or associated with the location of the user, assigned to other users. In some embodiments, the policy engine 222 may compare the number of assigned and unassigned workspaces 228 at each location of the user. Based on the comparison, the policy engine 222 may identify the location with the least number of assigned workspaces 228. From the location with the least number of assigned workspaces 228, the policy engine 222 may select one of the workspaces 228 to assign to the user that made the request. With a lower number of assigned workspaces 228, there may be more computing resources and/or bandwidth available to run and manage additional workspaces for additional users. In some embodiments, the policy engine 222 may compare the set of resources at each workspace 228 in the location with the least number of assigned workspaces 228 with the one or more resources indicated in the request from the user. Based on the comparison, the policy engine 222 may select the workspace 228 with the greatest number of available resources (e.g., matching the one or more resources indicated in the request).

In some embodiments, the policy engine 222 may identify or select the workspace 228 based on the type(s) of device(s) associated with the user at the indicated location. From the set of available workspaces 228, the policy engine 222 may identify types of devices compatible with each workspace 228. For example, certain workspaces 228 may be compatible with laptops and desktops, while other workspaces 228 may be compatible with smartphones. Out of the set of workspaces 228 identified as compatible with the types of devices associated with the user, the policy engine 222 may select one of the workspaces 228. In some embodiments, the policy engine 222 may compare the set of resources at each workspace 228 identified as compatible with the types of devices associated with the user, with the one or more resources indicated in the request from the user. Based on the comparison, the policy engine 222 may select the workspace 228 with the greatest number of available resources matching the one or more resources indicated in the request.

Once the workspace 228 is identified, the policy engine 222 may identify, select and/or configure one or more user interfaces for the workspace 228. The identification of the user interface may be based on the types of possible devices that the user at the location can operate. As previously discussed, the types of possible devices may include a smartphone, a tablet, a laptop, a desktop, a smart television, or any computing device. Each user interface for the identified workspace 228 may be configured to be presented on a particular type of device. For example, the workspace 228 may have one graphical user interface for a smartphone and another graphical user interface for a laptop. Based on the types of possible devices that the user at the location can operate, the policy engine 222 may identify one or more user interfaces for the workspace 228 configured to be presented on the types of possible devices.

The policy engine 222 may configure or otherwise set the preconfigured policies 226 maintained on the policy database 216. In some embodiments, the policy engine 222 may configure the set of policies 226 to assign to each of the possible locations, to one of the workspaces 228. Each policy 226 may specify one or more workspaces 228 for each possible geographic location or each possible network address for the user. For example, the policy 226 may be configured to assign a geographic location corresponding to the United Kingdom to a workspace 228 hosted in Europe. In some embodiments, the policy engine 222 may configure the set of policies 226 to assign a corresponding set of resources for the user to each possible location of the user. Each policy 226 may specify one or more resources for the user to be accessed via the workspace 228, for a respective geographic location or network address of the user. In some embodiments, the policy engine 222 may configure the set of policies 226 to assign each type of device that the user can operate with, to one or more of the workspaces 228. Each policy 226 may specify one or more types of devices that the user can operate with, to one or more workspaces 228. In some embodiments, the policy engine 222 may configure the set of policies 226 to assign one or more user interfaces from the workspaces 228 to each possible type of device that the user can operate. Each policy 226 may specify one or more user interfaces of the workspaces 228 to assign to each possible type of device that the user can operate to access the workspace 228.

With the identification of the workspace for the indicated location and having the one or more applications for the user, the workspace assigner 224 may assign the workspace 228 to the user. In some embodiments, the workspace assigner 224 may identify the workspace identifier corresponding to the identified workspace 228. As discussed above, the workspace identifier may be an address to access the remote desktop session for the workspace 228. In some embodiments, the workspace assigner 224 may also identify the user interface for the assigned workspace 228. In some embodiments, the workspace assigner 224 may generate a response indicating the assignment of the workspace 228 to the user. The response may include the workspace identifier corresponding to the identified workspace 228. In some embodiments, the response may include an identifier for the user interface to be used to access the workspace 228. Once generated, the workspace assigner 224 may transmit the response to the client 202.

Subsequently, the workspace requester 210 of the client 202 may receive the response indicating the assignment of the workspace 228 to the user from the server 204. The workspace requester 210 may parse the response to identify the assignment of the workspace 228. In some embodiments, the workspace requester 210 may parse the response to identify the workspace identifier corresponding to the workspace 228. The workspace requester 210 may apply the assignment of the workspace 228. In some embodiments, in applying the assignment, the workspace requester 210 may use the workspace identifier to access the workspace 228. In some embodiments, the workspace requester 210 may access the one or more resources available through the workspace 228 using the workspace identifier. In some embodiments, the workspace requester 210 may invoke another application to run and access the workspace 228 using the workspace identifier in the received response.

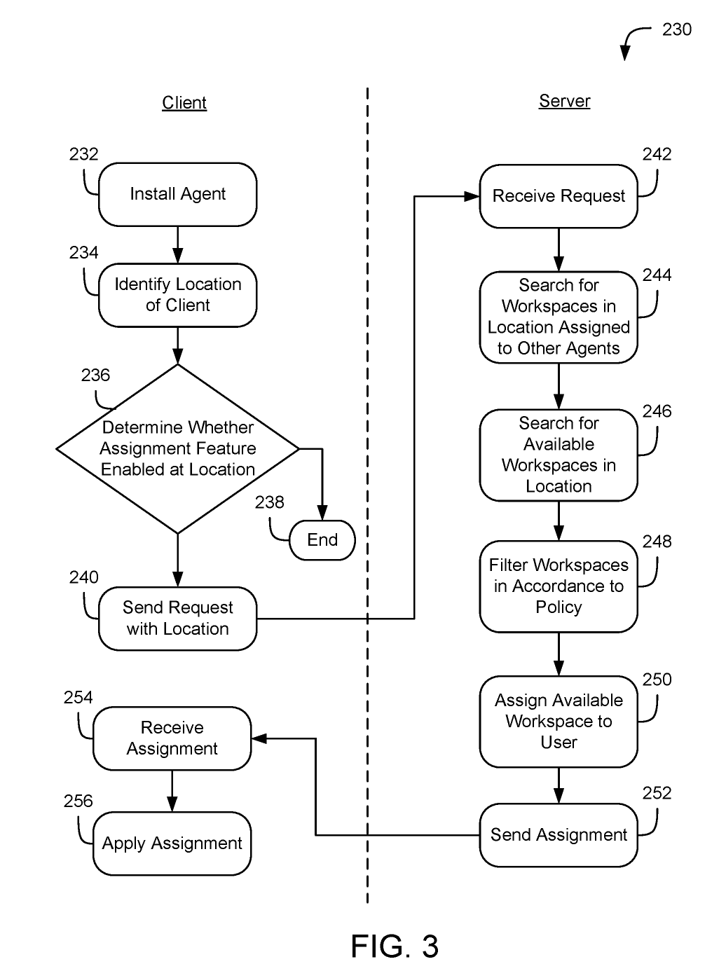

Referring to FIG. 3, depicted is an example sequence diagram of a method 230 of assigning workspaces. The operations and functionalities of method 230 may be implemented using, or performed by, the components described in FIGS. 1 and 2. A client may install an agent (232). The client may identify a location of the client (234). The client may determine whether an assignment by location feature is enabled for the location (236). If the assignment by location feature is not enabled, the method may terminate (238). Otherwise, the client may send a request with the location to a server (240). The server may receive the request from the client (242). The server may search for workspaces in the location assigned to other users (244). The server may search for available workspaces in the location (246). The server may filter the available workspaces in accordance to a policy (248). The server may assign one of the available workspaces to the user (e.g., responsive to the filtering) (250). The server may send the assignment to the client (252). The client may receive the assignment from the server (254). The client may apply the workspace assignment (256).

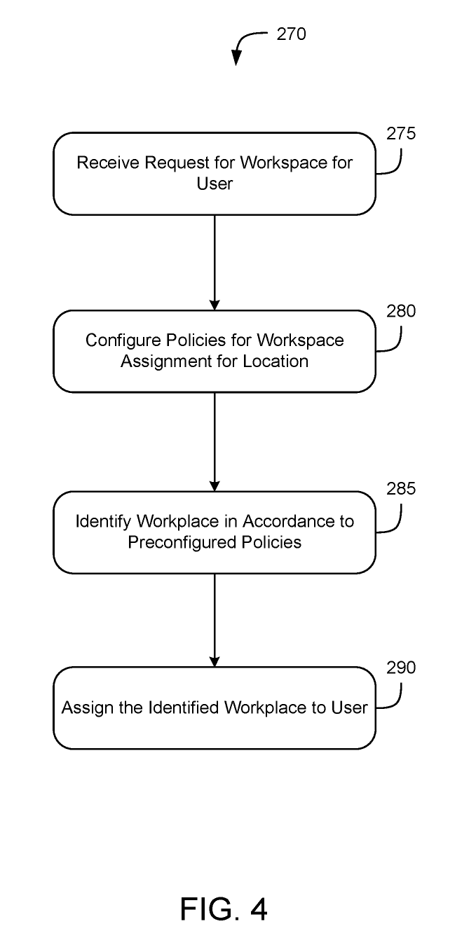

Referring to FIG. 4, depicted is an example sequence or flow diagram of a method 270 of assigning workspaces. The operations and functionalities of method 270 may be implemented using, or performed by, the components described in FIGS. 1 and 2 for instance. In brief overview, a workspace manager may receive a request for a workspace to assign to a user (275). The workspace manager may configure policies for workspace assignment for the location (280). The workspace manager may identify a workspace in accordance to the preconfigured policies (285). The workspace manager may assign the identified workspace to the user (290).

A workspace manager may receive a request for a workspace to assign to a user (275). The workspace manager may be executable on a server. The request may indicate a location of the user. The workspace manager may receive the request from a device of the user. The workspace manager may receive the request from an agent executing on the device. The device and/or agent can determine and/or provide the location of the user or the device. The location of the user may be a geographic location or a network address. Upon receipt of the request, the workspace manager may parse the request to identify the location of the user. The workspace manager may also identify or determine one or more resources for the user to be accessed by the user based on the location of the user. The one or more resources may include applications and/or data files. The workspace manager may also find a set of locations near (e.g., within a defined distance or proximity to the location) or otherwise associated with the location of the user indicated in the request.

The workspace manager may configure or preconfigure one or more policies for workspace assignment for the location (280). The policies may specify assignment of workspaces to users based on location. The policies may also specify one or more resources available at a particular workspace. The policies may further specify one or more possible device types compatible with a given workspace. The policies may additionally specify one or more user interfaces to be used in accessing the particular workspace. The workspace manager may configure or preconfigure one or more preconfigured policies to assign each of the possible locations of the user to at least one of the plurality of workspaces. For instance, location A for the user can be assigned to workspaces 1 and 2, while location B for the user can be assigned to workspaces 1, 3 and 4.

The workspace manager may configure or preconfigure the one or more preconfigured policies to assign a corresponding set of one or more applications to the user, for each of the possible locations of the user. For example, applications 1 and 2 (but not application 3) can be assigned to a workspace available to the user at country A (e.g., because the user or the user's employer is licensed to use applications 1 and 2 in country A, while application 3 is not supported in country A).

The workspace manager may configure or preconfigure the one or more preconfigured policies to assign, for/to each of a plurality of possible types of devices that the user can operate, one of the plurality of workspaces. For instance, a mobile device of the user may have limited capabilities to render or access certain workspaces or certain applications via a workspace. As such, the mobile device may be assigned with a workspace having a user interface and/or applications designed or configured for mobile devices.

The workspace manager may identify a workspace in accordance to the preconfigured policies (285). The workspace manager may identify, according to the one or more preconfigured policies, from a plurality of workspaces configured for possible locations of the user, a first workspace configured for the indicated location. The first workspace may have one or more applications predetermined for the first user and the indicated location. From the location of the user as indicated in the request, the workspace manager may identify a set of workspaces available for the location of the user. The workspace manager may also determine a set of workspaces currently assigned to other users at, near, or associated with the location of the user as indicated in the request. The workspace manager can identify or determine, from the plurality of workspaces configured for possible locations of the user, the first workspace according to a type of device associated with the user at the indicated location. The workspace manager may filter the set of workspaces available at the location of the user, using the set of location identified as assigned to other users at the location. The workspace manager may also filter the set of available workspaces using the one or more resources to be used by the user, the one or more possible device types that the user can operate, and/or the one or more interfaces for accessing the workspace. For instance, responsive to the filtering, the workspace manager may identify one workspace to be assigned to the user. The workspace manager may identify a reference identifier corresponding to the identified workspace.

The workspace manager may assign the identified workspace to the user (290). The workspace manager may assign to the user the identified first workspace configured for the indicated location and having the one or more applications predetermined for the first user and the indicated location. With the identification of the workspace, the workspace manager may generate a response indicating the assignment of the workspace to the user. The response may also include the reference identifier corresponding to the corresponding workspace. Once generated, the workspace manager may transmit the response to the client. Using the reference identifier included in the response, the user may access the assigned workspace.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for assigning workspaces, the method comprising:
receiving, by a workspace manager executable on a server, a request for a workspace to be assigned to a user, the request indicating a location of the user;
identifying, by the workspace manager according to one or more preconfigured policies, from a plurality of workspaces configured for possible locations of the user, a first workspace configured for the indicated location and having one or more applications predetermined for the first user and the indicated location; and
assigning, by the workspace manager to the user, the identified first workspace configured for the indicated location and having the one or more applications predetermined for the first user and the indicated location.

2. The method of claim 1, further comprising receiving the request from a device of the user, the device determining the location of the user.

3. The method of claim 1, further comprising receiving the request from an agent on a device of the user, the agent received from the server for execution on the device.

4. The method of claim 1, further comprising configuring the one or more preconfigured policies to assign each of the possible locations of the user to one of the plurality of workspaces.

5. The method of claim 1, further comprising configuring the one or more preconfigured policies to assign, for each of the possible locations of the user, a corresponding set of one or more applications to the user.

6. The method of claim 1, further comprising configuring the one or more preconfigured policies to assign, for each of a plurality of possible types of devices that the user can operate, one of the plurality of workspaces.

7. The method of claim 1, further comprising configuring the one or more preconfigured policies to assign, for each of a plurality of possible types of devices that the user can operate, one of a plurality of user interfaces from the plurality of workspaces.

8. The method of claim 1, further comprising identifying, from the plurality of workspaces configured for possible locations of the user, the first workspace according to a type of device associated with the user at the indicated location.

9. The method of claim 1, further comprising:
determining, by the workspace manager, workspaces of other users at the indicated location; and
identifying the first workspace according to the determination.

10. The method of claim 1, wherein the identified first workspace comprises a remote desktop session.

11. A system for assigning workspaces, the system comprising:
memory of a server for storing one or more preconfigured policies; and
a workspace manager executable on the server, the workspace manager configured to:
receive a request for a workspace to be assigned to a user, the request indicating a location of the user;
identify, according to one or more preconfigured policies, from a plurality of workspaces configured for possible locations of the user, a first workspace configured for the indicated location and having one or more applications predetermined for the first user and the indicated location; and
assign to the user the identified first workspace configured for the indicated location and having the one or more applications predetermined for the first user and the indicated location.

12. The system of claim 11, wherein the workspace manager is configured to receive the request from a device of the user, the device determining the location of the user.

13. The system of claim 11, wherein the workspace manager is configured to receive the request from an agent on a device of the user, the agent received from the server for execution on the device.

14. The system of claim 11, wherein the workspace manager is used to configure the one or more preconfigured policies to assign each of the possible locations of the user to one of the plurality of workspaces.

15. The system of claim 11, wherein the workspace manager is used to configure the one or more preconfigured policies to assign, for each of the possible locations of the user, a corresponding set of one or more applications to the user.

16. The system of claim 11, wherein the workspace manager is used to configure the one or more preconfigured policies to assign, for each of a plurality of possible types of devices that the user can operate, one of the plurality of workspaces.

17. The system of claim 11, wherein the workspace manager is used to configure the one or more preconfigured policies to assign, for each of a plurality of possible types of devices that the user can operate, one of a plurality of user interfaces from the plurality of workspaces.

18. The system of claim 11, wherein the workspace manager is further configured to identify, from the plurality of workspaces configured for possible locations of the user, the first workspace according to a type of device associated with the user at the indicated location.

19. The system of claim 11, wherein the workspace manager is further configured to:
determine workspaces of other users at the indicated location; and
identify the first workspace according to the determination.

20. The system of claim 11, wherein the identified first workspace comprises a remote desktop.
